(19) United States
(12) Patent Application Publication
(10) Pub. No.: US 2009/0018865 A1
(43) Pub. Date: Jan. 15, 2009

(54) Earnest custom calibration system delivering dietary supplements

(76) Inventor: Carmella Lynn Earnest, Griffithsville, WV (US)

Correspondence Address: Carmella Lynn Earnest, HC 78 Box 128, Griffithsville, WV, 25521, US

(21) Appl. No.: 11/827,473

(22) Filed: Jul. 12, 2007

(51) Int. Cl. G06Q 50/00

(52) U.S. Cl. 705/2

(57) ABSTRACT

The present invention relates to the delivery of emulsions and dry powders mixed to supply a customized calibration of dietary supplements derived from the coordinated efforts of the user, the user's physician, and the user's supplier or pharmacy. The system of utilization is three pronged and coordinates all three venues into development of a safer, purer, quality, product accessible through manual, electronic, and internet applications for its production and procurement which is user specific and personal and it additionally affords inherent, by virtue of attending professionals, medical checks and balances on its use.

### CROSS-REFERENCE TO RELATED APPLICATIONS

Not applicable.

### STATEMENT REGARDING FEDERALLY SPONSORED RESEARCH OR DEVELOPMENT

Not Applicable. No Federal Sponsorship.

### THE NAMES OF THE PARTIES TO A JOINT RESEARCH AGREEMENT

There are no other parties to any joint research agreement. There is only one true Inventor, Carmella Lynn Earnest.

### INCORPORATION-BY-REFERENCE OF MATERIAL SUBMITTED ON A COMPACT DISC

Not applicable.

### BACKGROUND OF THE INVENTION

1) Field of the Invention

The present idea and invention creates a composition and delivery system of matter having useful physiological and nutritional activity, coordinating older fields of medicine and pharmacology, and creating a novel new application integrating newer related fields of health, nutrition, and the psychological aesthetic impact of ‘quality of life’ as they combine synergistically creating a new use for these old fields.

### OBJECTS

Our primary nutritional supply system, aka, food supply, is taking a serious nose dive with the depleting effects on the nutritional values of processed foods, and genetically engineered and fast foods taking a toll on our health and leaving our population in a nutritional deficit.

In trying to remedy these national health disasters the medical, health and nutritional supplement industries are burgeoning, they have become a huge, chaotic, dispersed, and disorganized morass of options with no guide posts or markers to direct or to intervene or even create a safety net.

To make matters worse we have an aging population requiring more nutritional augmentation due to the aging process and a population that is more dependent on medication to correct health maladies and alleviate illness and diseases, many of which are compounded by the nutritional heath deficit.

This third effect has created a monster of conflicting and sometimes deadly results between the food we consume and the medications we take, for lack of coordination and information we are a dependant culture of dangerous drug contraindications with our foods! Most of which the public is unaware.

Because the industries, medicine, nutrition, supplements, homeopathics, have grown so large, it has become impossible to sort out all the effects of one on another, leaving us with a situation so complicated, no one has been able to organize the disparate chaos into a manageable venue.

For those who are and have been using supplements to correct the problems of age, stress, and cumulative toxins it has become job just to read, retrieve, and try the options at our disposal, the time consumed in managing our own personal health is its own waste of time which none of the above industries has solved or expedited.

The broad array of brands delivering our supplement fix is at best not fresh, and at worst full of binders and fillers and for some people contains dangerous allergens which are not always known or labeled.

It looks as though the industries that underwrite these products from food to medication are in trouble.

### ADVANTAGES

THE EARNEST CUSTOM CALIBRATION SYSTEM DELIVERING DIETARY SUPPLEMENTS can fix these industry and life style related health problems or at least a good bit of them by:
1. Offering access to the purest, highest quality, fresh pharmaceutical grade dietary supplements.
2. Offering a one stop shopping and delivery system creating a personalized dietary supplement product as part of a simplified comprehensive nutritional supplement regimen.
3. Providing a safety net built on qualified experienced Doctors and Pharmacists who provide the Earnest System with expertise and know the latest, most front line information in the industry.
4. Preventing contraindications with other medication through Pharmacist and Physician reviews of the users regimen in comparison with users medications and medical history.
5. Customizing the product allowing for screening of any commercial product additive or user specific allergens thereby avoiding any user specific reactions or side effects from the regimen.
6. Knowing how to build each persons regimen so that the individual components work with one another and not against one another.
7. Providing a synergistic system that integrates the disparate industries into one functional, easy to use system, user friendly, and user personal. The whole here is definitely greater than the sum of its parts, even though the solution is inversely proportional to the size and volume it simplifies!
8. Combining the user, doctor, and pharmacist seems a perfectly simple solution to the problems plaguing these industries, and curiously, no one devised this simple solution before now.

### An Interesting Case:

Experimentation carried out with this application embodiment was tested on the true inventor and supports via a “parent case” the improved accessibility, digestibility, and metabolic utilization of these pharmaceutical supplements, purifying, and detoxifying the user in some instances correcting that person's physical and mental health issues with beneficial, non-allergenic, and therapeutic effects.

2) Description of the Related Art Including Information Disclosed Under 37 CFR 1.97 and 1.98.

As above only. No cites.

### BRIEF SUMMARY OF THE INVENTION

The exact nature of this embodiment is to deliver for utilization a customized dietary supplementary composition calibrated specifically and created exactly for the user's consumption and well being. The operation of this embodiment is adapted to coordinate, involve and utilize the users physician, who knows that user's medical history, and to involve and utilize that users pharmacist, who knows that users medications and history.

The further purpose of this embodiment is to create a state of the art delivery process for this customized calibration, with checks and balances to minimize any adverse effects from the utilization of dietary supplements.

### BRIEF DESCRIPTION OF THE SEVERAL VIEWS OF THE DRAWING(S)

No drawings.

### DETAILED DESCRIPTION OF THE INVENTION

In accord with medical and pharmacological guidance inherent in this dietary supplement delivery system, the user, embodied with a specifically customized regimen, prescribed and approved by that users physician and pharmacist, will enjoy certain positive health benefits without many of the side effects or risks present when taking commercially produced supplements and will gain a safety net having this regimen coordinated and edited using past medical history and present medications. It is believed by an ever expanding audience, lay and professional alike, dietary supplements are producing positive and far reaching health benefits for their users. This particular system's customized service, addresses each individual user's needs. Enjoying the positive health, well being, and improved quality of life desired by these user's is simpler and more efficient because all the supplements are contained in one regimen product.

### CONCLUSION, RAMIFICATIONS, AND SCOPE

### Conclusion

The driving factor, idea, behind this proposal stems from my last year, spent sorting through volumes of medical confusion about a kidney mass which I had removed by cryoablation, all during this patent application period. In an attempt to dean up my life, I had my doctors help develop a supplement regimen for me and then I went to my pharmacist to compound these doctor prescribed dietary supplements and to avail the purest, least adulterated ingredients all in one place and without the gelatin I was toxic on. I went to my pharmacist to see if they could produce the mix for me. The result is this patent application. The pharmacist got very excited about the potential for my idea and I did let him know at the onset I was writing it up as a patent application. I too was excited about it.

The kidney mass was only scar tissue and I learned by testing everything I ingested that my lifestyle was pretty clean. Now, I want to share my good fortune and good health with as many people as possible by offering this same service to anyone who wishes to use it. My doctors are known throughout this area for keeping terminal cancer patients alive for decades among other remedies they prescribe dietary supplements. This is good for everyone!

The concluding point to all of this is that the system offered here is a powerful solution to a huge cultural problem, nutrition, and one that is far reaching and many faceted in terms of quality of life for many and in solving personal health problems for others. There is no substitute for the personal attention which this service offers. The synergism among the three entities, User, Doctor and Pharmacist is invaluable. Nothing offered could match this system for its quality controls all around, No one is more attentive to a health issue than the person who has it. Their Doctors and Pharmacists are the greatest assistants to self healing.

### Ramifications

This proposed system has room for expansion. Even though it is designed primarily for human use it is possible to use the same idea to address animals using veterinary medicine and veterinarians to implement a regimen. This is a new area of animal nutritional supplements which has great potential for good works and would prove lucrative.

Another expansion possibility involves the business model for processing and delivering the product. It is slated for the next six months to develop a website for this project and from there it will be history.

This system is capable of handling an infinite number of compounds once it is in place and can be updated indefinitely as new discoveries are made and old remedies are enhanced and used in new ways. All updates can be inserted as part of the evolving process.

Some forty years ago I was employed with ‘Top Secret’ status in NIH contract with Tracor to work on “A Researchers Guide to Carcinogenic Compounds”, taking every known writing of international data on subject and reducing that information into a usable system. Perhaps the present project could be expanded, contracted, and effectively categorized into some very useful systems also. I could handle the job if it ever came to that level of task.

One possibility is to expand this patent application idea project into international areas.

Still another is to design a machine like a pill maker to use for calibrations, simplifying the process and allowing for more people to receive cheaper product; a good dream.

### Scope

The EARNEST CUSTOMIZED CALIBRATION SYSTEM DELIVERING DIETARY SUPPLEMENTS is not to be construed as limited in any one way by embodiments, but is a concept to be understood according to the spirit and scope of the claims with deference to those skilled in the art and modifications and variations which may be an inherent part of the process.

I claim:

1. This present embodiment is a process of service and a methodology for creating and delivering to an Individual, as a User, a regimen of customized supplements, titled EARNEST CUSTOM CALIBRATION SYSTEM DELIVERING DIETARY SUPPLEMENTS, Formulation, and is a means coordinating concerted efforts of three participating Entities, those being the User, as an Individual, a compound Supplier, as in a Pharmacist, and a Medical Provider, as in a Physician, all of whom synergistically contribute and coordinate their expertise and information creating a specific supplementary product for the User, said Formulation.

2. A new use methodology actualizing in this process of service and according to claim 1, herein involving three old adversaries, territorial, competitive, conflicting, industry fields, the Entities, often at combative loggerheads, now in this embodiment are synergistically integrate their areas of expertise into a new productive mode, expediting the process through the
a. Individual, User, who by delivering symptoms to the
b. Medical, Physician, alleviates the User's ill health symptoms with Supplements, refers orders to
c. Pharmacist, Supplier, who knowing and understanding the origins of the drugs which the Physician employs, and who, acting in this new role as Intercessor, sandwiched between the User and Physician, delivering benefits of traditional drugs with a milder often more original form of those traditional drugs known as dietary supplements, thereby integrating the other two Entities.

3. A method according to claim 1, wherein the embodiment is a means providing a specific, customized, composed, compounded, calibrated dosage, pure, high quality, pharmaceutical quality, pharmacologically acceptable, orally administered, dietary, and nutritional supplement regimen, the Formulation, comprised of originals and derivatives, and from any and all animal, mineral, and vegetative sources, singular and plural compounds, mixes, organic, elemental, molecular, living, non-living, simple, complex, physiologically active, inert, nutritional, dietary, ingestible, orally administered, not limited to the present realm of known or utilized supplements, but to be inclusive of any and all future discoveries and uses of said supplements selected form the ever-expanding and changing realm, albeit, ‘in toto’, list of mammalian nutritional dietary and additive group, comprised, utilized, and coordinated by the Entities, in dosages and frequencies administered for alleviating symptoms, improving the quality of life, providing product quality, and said Formulation being available for accessing, viewing, and screening by the Entities in preparation for the User.

4. A method according to claim 1, wherein the means for Initiating and creating the Formulation, is derived and initiated from any of the Entities, and may follow any one of the many routes of permutation among and between those three Entities since all three are weighed Into the synergistic development equally, all have equal access to the embodiment, and all have equal status to check and balance the supplementary Formulation.

5. A method according to claim 1, wherein any and all Formulations are calibrated and customized by qualified pharmaceutical personnel and with Industry standard safety checks, said being composed of pharmaceutical quality ingredients, and delivered with a reasonable degree of medical certainty and by a verifiable Supplier, as a Pharmacist, calibrated by any system of weight, volume, proportion, and composition, using any acceptable standard which that industry dictates, and with at least one or more ingredients to be compounded into the Formulation.

6. A method according to claim 1, wherein any and all of a multitude of pharmaceutical grade compound ingredients are selected from a broad and ever changing and expanding range of qualifying Ingredients, a plurality of which are and will be available, and in dosages specific to that User's medical history and medications, and with all Entities coordinating the dietary supplements in tandem with that information, enabling the Entities to coordinate and screen non-compatibles, co-compatibles, and customize the applications of said compounds within the Formulation.

7. A method according to claim 1, whereby these Formulations are at periodic intervals produced as fresh preparations for the User, and, wherein, the designated compositions are supplied to the User in a delivery form consisting of, but not limited to, any and all powder, water, oil, including any and all other inert and otherwise, ingestible emulsions, liquids or mixes, and with any other additional and appropriate additives included for palatability, as example, Vanillin, at the request of the User or under discretion of the licensed Supplier.

8. A method according to claim 7, whereby objections to particular tastes of the calibrated mixtures, necessitates the Formulation embodiment regimen be used with a medically and pharmaceutically supervised palative and in accord with the individual User's taste tolerances, the Formulation contents could be added to a palatable conveyance of the User's choice, such as, juice, water, yogurt, chocolate, milk, shakes, smoothies, and so on, upon medical approval and compatibility verification and Instruction from the Entities.

9. A method according to claim 1, whereby these orally administered customized supplement Formulations are to be as free as possible of unnecessary carriers, diluents, fillers, allergens, and any thing which might be a User specific contaminant, for example, a User may be sensitive to a normally passive ingredient which is a known to the User as a cumulative toxin, specifically, the gelatin from gelatin capsules, but by using pharmaceutical grade compounds comprising this formulation, the compound mix Supplier eliminates unnecessary additives or toxins, creating as pure a quality product as possible, and a product as physiologically and pharmacologically acceptable and safe to the User as possible with a reasonable degree of medical certainty and common knowledge and the editing Entities.

10. A method according to claim 1, wherein said Formulation is custom created by the Entities and is suggested for Users already into a supplement regimen, offering simplification, and for those who want to begin an orally administered regimen and Formulation of this quality, and, wherein, these supplements are medically supervised and offered with an unlimited range of dosage possibilities, ranging from 0 to infinity, but not limited by the varying national and international systems of measurement, metric or otherwise, to secure amounts, weights, and volumes and within a reasonable degree of medical certainty and common knowledge as directed by the Entities are available by application to anyone.

11. A method according to the embodiment of claim 1, resulting in delivery of a distinct product, the Formulation, created specifically for one User by the Pharmacist, said product is the embodiment resulting from the synergistic flow of Entity contributions, User, Doctor, Pharmacist, creating, ultimately, for the User, a Formulation containing orally administered, customized supplementation as an Order to be filled by the Pharmacist Supplier Including:
a. ingredients, any and all supplements as described,
b. dosages, by weight and volume as described, and,
c. frequencies, when and how often used.

12. A methodology to deliver the embodiment of claim 11, involving a system of listing the desired supplements for review by the Entities and production, and said list being utilized by the Pharmacy Suppliers and compound preparers, and whereby, the original and true inventor ordering a trial run as User of the EARNEST CUSTOM CALIBRATION SYSTEM DELIVERING DIETARY SUPPLEMENTS, Formulation, resulting in this first purchase on Jul. 14, 2006, thereby illustrates the system's workability and producing the following examples to Illustrate the utility and salability of this system's product:
FIRST PART
B-Complex plus per 10 ml(cc) suspension
10 ml twice daily 300 ml = 15 days shake well

| | | |
|---|---|---|
| 1. THIAMINE HYDROCHLORIDE USP | 0.1 | GM |
| 2. BIOTIN (D) USP (VITAMIN H) | 0.01 | GMS |
| 3. RIBOFLAVIN (VITAMIN B2) POWDER | 0.1 | GM |
| 4. PYRIDOXINE HYDROCHLORIDE USP | 0.1 | GM |
| (VITAMIN B6) | | |
| 5. FOLIC ACID, USP POWDER | 0.001 | GM |
| 6. COENZYME Q10 POWDER | 0.1 | GM |
| 7. INOSITOL POWDER 0 | 0.65 | GM |
| 8. PHOSPHATIDYLCHOLINE POWDER 40 | 0.45 | GMS |
| 9. STEVIOSIDE 90% POWDER | 0.01 | GMS |
| 10. SILICA GEL (MICRONIZED) POWDER | 0.2 | GMS |
| 11. GLYCERINE LIQUID | 2.0 | ML |
| 12. POLYSORBATE 80 NF LIQUID 100 | 0.2 | ML |
| 13. METHYLCELLULOSE 2% GEL 2 | 5.0 | ML |
| 14. FLAVOR (ANY) LIQUID | 0.35 | ML |
| 15. WATER, PRESERVED LIQUID | 10.0 | ML |

SECOND PART
FORMULA 3-MINERAL POWDER
45 DOSES

| | |
|---|---|
| 1. CALCIUM CITRATE TETRAHYDRATE | 126 GMS |
| USP POWDER | |
| 2. MAGNESIUM OXIDE LIGHT POWDER | 22.5 GMS |
| 3. ZINC PICOLINATE POWDER | 0.675 GMS |
| 4. MANGANESE GLUCONATE DIHYDRATE, | 0.225 GMS |
| USP POWDER L | |
| 5. FLAVOR, VANILLIN NF POWDER | 4.0 GMS |

WEIGH ALL POWDERS AND MIX WELL
DOSE = 1 SCOOPFUL 3 TIMES DAILY
amounts and compounds vary with each individuals needs and request order list, but this calibration was created under the auspices of “Trade Secret” by the true inventor's pharmacy with their full acknowledgement that the true inventor was applying to patent the idea embodiment herein.

14. This embodiment according to claim 1, providing a means for accessing the Formulation through a business model delivery system ultimately producing the Formulation product, marketing it through an Order Application Form, requesting specific contents, dosages, modes, and frequencies, Entities reviewing said for medical safety, Pharmacy preparing and filling said Forms for Orders, being available manually, electronically and via internet for generation into a hard copy Order requests, its composition embodiments set forth in this document, and being available for purchase.

15. A method according to claim 14, providing a safe plan, accessible to all Users as well as the three Entities, thereby allowing access, review, and edification for each Formulation product, providing each Entity with a Document of Record before, during, and after purchase, insuring the Users physician and pharmacist receive User's information and application, registering a physician for the User, validating the Formulations purchase, and registering said Information for extended medical and pharmaceutical checks, thereby minimizing and mitigating, if not eliminating, the Industry's ever present dangers of a User's unregulated non-documented supplement regimen working as a contraindication to the Users good health.

16. A method according to claim 14, delivering information for the Formulation embodiment requests, and for their users, and providing an interactive dialogue once the service has been initiated, whereby interested Users accessing the system will be continuously updated and Informed on supplement options used in their Formulations, selection, dosages, frequencies, and application, with options for dialogue with their physicians or proxys, providing User and Public at Large, the ability to build and request the Formulation contents manually, electronically, or via Internet, and allowing production of hard copy of selected supplemental Formulations, send copy for Physician and Pharmacy review, and, ultimately, submitting orders and appropriate filing, and any other service which may be applicable to expedite this process in the future.

17. A method according to claim 14, which utilizes the delivery of these Formulated customized calibrated dosages of supplement for any recipient, human, animal, mammalian or otherwise, to include any User, whether the User be a person, client, participant, agent, animal, virtually any being that could benefit from the service of this Formulation delivery methodology.
